(19) United States
(12) Patent Application Publication
(10) Pub. No.: US 2023/0144115 A1
(43) Pub. Date: May 11, 2023

(54) Integrated Sports Trading Card with Near Field Communication

(71) Applicant: Brandon Selfridge, Alabaster, AL (US)

(72) Inventor: Brandon Selfridge, Alabaster, AL (US)

(21) Appl. No.: 17/520,614

(22) Filed: Nov. 5, 2021

(51) Int. Cl. A63F 1/18; G06K 19/04

(52) U.S. Cl. CPC A63F 1/18; G06K 19/041; A63F 2001/008

(57) ABSTRACT

Disclosed in the present invention is a Near Field Communication (NFC) technology in which a sports trading card is integrated with near field communication for con tactless communication and transmission of information to smart phone via a browser after the registration. Also disclosed is a method of integrating near field communication tag in the middle of the back of a sport trading card. The said comprises steps of tagging NFC to the middle back of NFL sports card, programming the tag of a player to their NFL.com site, laying the card face down and tag up, spraying the back of the card with white spray paint, letting the paint to dry, adding an NFL logo sticker to the back to cover up the NFC tag, scanning users phone to pull up the website to see information highlights of the player, pulling up the specific players statistics, news and highlights.

### TECHNICAL FIELD

The present invention relates to near field communication (NFC) technology, and in particular to sports trading card that is integrated with near field communication for contactless communication and transmission of information to smart phone via a browser after the registration.

### BACKGROUND ART

Over the past many years sport trading card have been available. It is small card made out of a paper board or thick paper which usually contain an image of a certain person, place or thing (fictional or real) and short description of the picture along with other text (attack, statistics). Trading cards are associated with sports. These cards include baseball cards, National Football League (NFL) (a professional American football league consisting of 32 teams, divided equally between the National Football Conference and the American Football Conference), NBA and etc. Today, the development of the internet has given rise to various communities through which a member can trade collectible cards is a multi-million-dollar industry through commercializing e-commerce communities for example EBay, Amazon etc.

When you mention ‘NFC’ to the average American sports fan, they might not immediately think of Near Field Communication technology, a short-range wireless connectivity standard that uses magnetic field induction to enable communication between devices. Instead, they might think of the National Football Conference, which makes up one half of the NFL; the other half is the American Football Conference, known as the AFC). The NFC is full of some very famous and iconic teams, such as the Dallas Cowboys, the Green Bay Packers and the San Francisco 49ers, so don't be surprised if that's what is thought of first. Can contactless technology improve sports in general? The answer is yes.

The value of a trading card depends on a combination of many factors. The subject card popularity, the card condition state and the scarcity of the card in question. Popularity is determined by the subject real-life achievements and short-term highlights as well attributes of his gameplay of the subject. The value of some of cards have skyrocketed to millions of dollars because of the love for the game, fans love for subject attached to the card.

The game changer has been brainstormed to change ways or usual norm of dealing with these cards. Installation of cards in the recent technology such as near field communication chip has also revolutionized the economy. Near Field Communication (NFC) tag is programmed depending on the subject on the card and is placed at the back of card so once swapped to smartphone to redirect the user to respective browser. It is used to pull up information of the player.

Since the introduction of sporting cards, no such invention has been invented. The prospects of this invention are high and widely accepted. The value of cards is picking up depending on card condition. So, NFC technology will bring about authenticity to industry to prevent scam cards on market which are on circulation.

### OBJECTIVES OF THE INVENTION

The first object of invention is to develop NFC tag on sports trading card for contactless communication to pull up information of player on the card on regards to his career displayed on the smartphone.

The second object is to automate sports trading cards that will expand the sports betting industry.

### SUMMARY OF THE INVENTION

The present invention presents sports trading cards e.g., NFL, MLB and NBA integrated with NFC technology for contactless communication and transmission of information to smart phone via a browser after the registration of NFC tag. The player career highlights are displayed on the browser. In case the player retired lifetime statistics are displayed and current situation of player career. NFC chip will be programmable and attached at the back of card and connection will be established through radio frequency to nearby phone already connected to the internet via broadband or wireless fidelity.

As disclosed in the present invention is a sporting card tagged with a NFC tag at the back of the card aligned at the Centre. The chip is already programmed such that within few centimeters of each other to exchange information wireless with a smartphone.

As disclosed depending on the subject on the sporting card it will enable users to pull off data about the player after synchronization with smartphone which entails registration of tag on card it redirects the browser on the smartphone with such a case the phone should he connected to the internet. On the browser page it shows player career statistics and latest highlights and news.

It is just application of the near field communication technology and attaching it already to existing sporting card technically. In accordance with aspect of invention there is a provided near field communication attached at the back of card in that its already programmable and contain information about the subject on the card. it transmits information on NFC tag reading module to another party in this case the smartphone which request information about the first object from a remote server which it displays on browser page. Phone must be connected to internet to gather that information from a remote server.

In one embodiment information displayed on the phone is associated with information of first object (sports card). NFC tag comprises at least a capacitor coupled into integrated circuit to facilitate the tuning of frequency of the tag which is unpowered. the second party is powered which facilitate connection once established.

### BRIEF DESCRIPTION OF FIGURES

FIG. 1 represents the overview front view of a phone and sporting card icon App

FIG. 2A represents the illustration of back view of a phone showing location of NFC tag

FIG. 2B is a demonstration of insertion NFC tag and sticker

FIG. 3A is typical NFC tag.

FIG. 3B is a completed prototype of NFC tag when programmed and painted with sticker

FIG. 4 is an illustration of NFC tags on the card to a cell phone

FIG. 5 is an illustration of pulled off players information on user smartphone with statistics

FIG. 6 is a schematic demonstration of a method of making a sports trading card with integrated NFC tag as described in the present invention.

### DETAILED DESCRIPTION OF THE INVENTION

In a more detailed description, the present invention teaches of a sports trading card with an integrated NFC technology in which NFC is tagged on the back of National Football League (NFL) sports card for contactless communication and transmission of information to smart phone via a browser after the registration. NFC tag on the back of the trading cards of National Football League NFL sports cards, and other sports such as MLB and NBA.

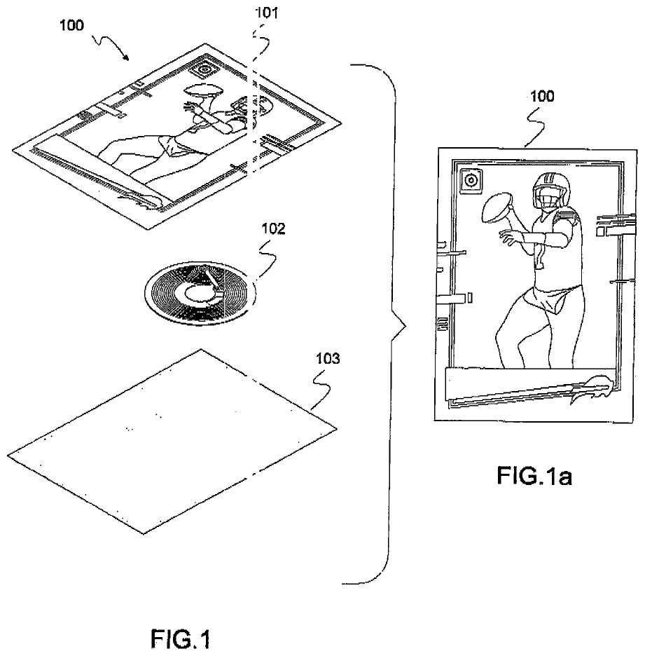

In one embodiment according to FIG. 1, the invention presents a phone (1) and sporting card icon App (2) as programmed to show the players career highlights that are displayed on the browse. In case the player retired lifetime statistics are di splayed and current situation of player career. NFC chips are programmable and attached at the back of card and connection is established through radio frequency to nearby phone already connected to the internet via broadband or wireless fidelity.

A sporting card is tagged with NFC tag at the back of the card aligned at the centre. The programmed chips are placed such that within few centimeters of each other to exchange information wireless with a smartphone.

As disclosed depending on the subject on the sporting card it will enable users to pull off data about the player after synchronization with smartphone which entails registration of tag on card it redirects the browser on the smartphone with such a case the phone should be connected to the internet. On the browser page it shows player career statistics and latest highlights and news.

It is just application of the near field communication technology and attaching it to existing sporting card technically. In accordance with aspect of invention there is a provided near field communication attached at the back of card in that its already programmable and contain information about the subject on the card. it transmits information on NFC tag reading module to another party in this case the smartphone which request information about the first object from a remote server which it displays on browser page. Phone must be connected to internet to gather that information from a remote server.

In one embodiment information displayed on the phone is associated with information of first object (sports card). NFC tag comprises at least a capacitor coupled into integrated circuit to facilitate the tuning of frequency of the tag which is unpowered. the second party is powered which facilitate connection once established. As displayed on FIG. 1, discloses a sports card that shows an image of a player in respective of game he/she plays and name of the subject in question and other cases statistics of he/she game statistics.

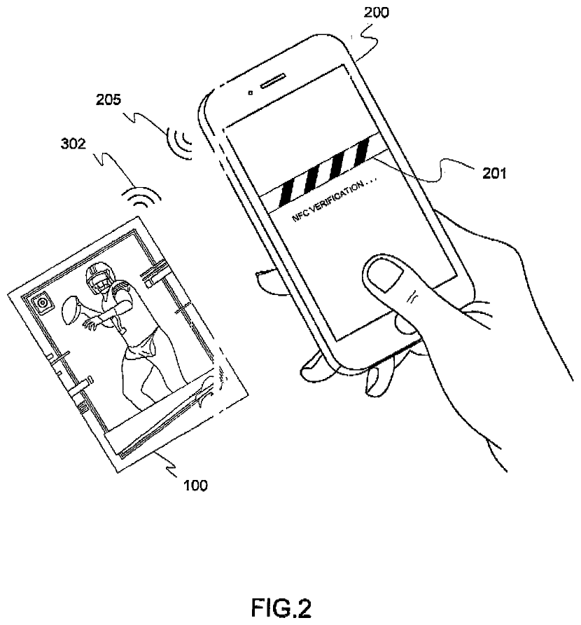

In FIG. 2A, the invention shows NFC sticker aligned at the center of back view of a phone (1) showing location of NFC tag (3) which allows communication between it and a smartphone at different frequency and data rate speed. it is based on inductive coupling between so called antennas on NFC-enabled devices. Once programmed NFC tags store passive data stores that can be read in respective to the sport card attached It may be rewritable to enable future changes on the subject matter. FIG. 2B is a demonstration of insertion (4) NFC tag and sticker. Radio frequency identification is applicable and deployed since it communicates with the smartphone. In addition, when one of the connected devices has internet connectivity it enables exchange of data with online services in this case in respective to their sporting web site. Infringement of copyright and licenses have adhered to. Data between the tags will be encrypted to prevent crosswalks and infringement.

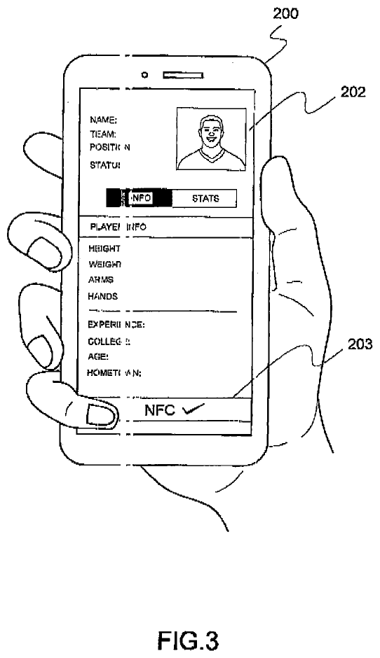

FIG. 3A is typical NFC tag (5). FIG. 3B is a completed prototype of NFC tag (5) when programmed and painted with sticker.

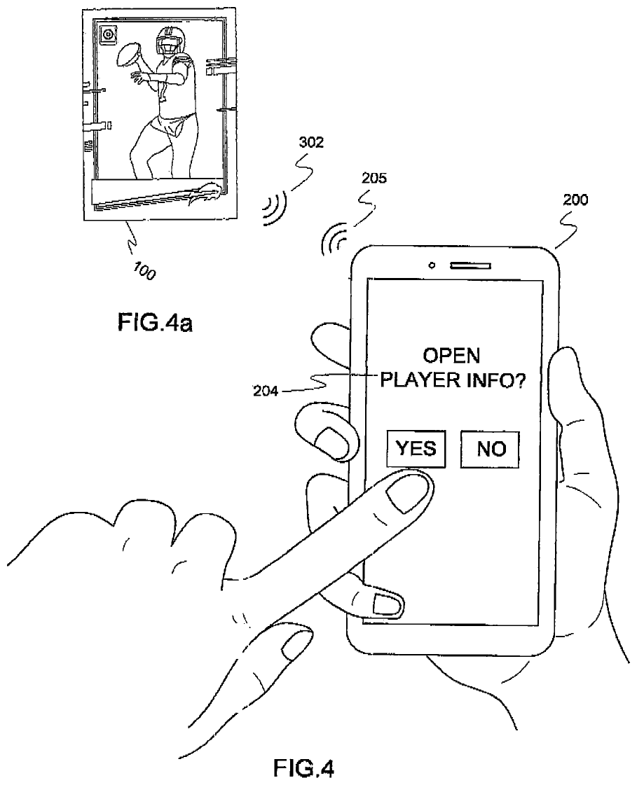

In FIG. 4, the invention shows the locations of NFC tags on the card to a cell phone. It shows the way the card will be placed on the phone since the card is unpowered once the peer-to-peer communication is done and initiated the phone generates a radio frequency which powers the card although contactless. The tags are custom-encoded to meant the specifications using radio frequency once connection is done data is securely transmitted to the phone. Realistically the most convenient distance to communicate is several centimeters. Too much further the pickup antenna may be quenched by nearby interference such as metallic objects. Smartphone software developers such as IOS and android developers allow their phones to read data from third party devices in this case sport trading cards.

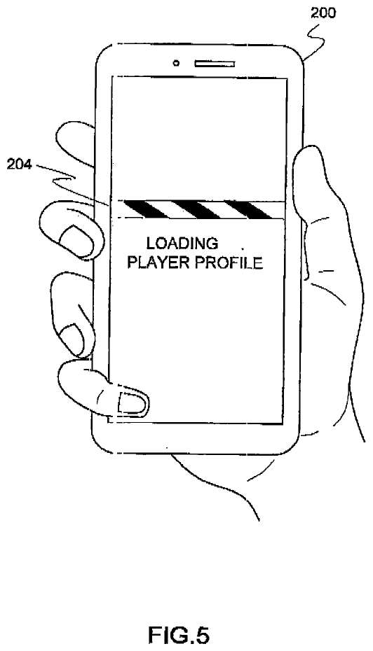

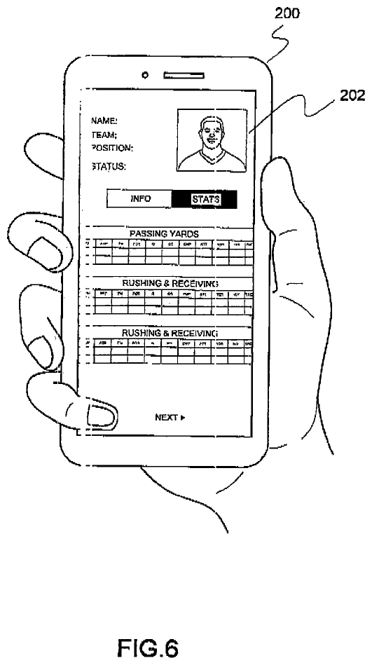

In FIG. 5 once the connection is established the information as shown on the diagram will be displayed on the phone pulled off from the website it shows the player highlights and statistics according to his gameplay. If the player retired it will show his lifetime achievements. FIG. 6 teaches of a novel method of integrating near field communication tag in the middle of the back of a sport trading card used for contactless communication and transmission of information in a smartphone via a browser after the registration with steps (601-605).

### THE BEST MODE OF CARRYING OUT THE INVENTION

At its best, the present invention teaches of a Near Field Communication (NFC) technology in which a sports trading card is integrated with near field communication for contactless communication and transmission of information to smart phone via a browser after the registration. In first embodiment, the sport trading card, comprises an integrated near field communication for contactless communication and transmission of information to a smartphone via a browser after the registration. The near field communication is integrated at the back of sports card and aligned at the centre with the already programmed chips such that the said chips are within few centimeters of each other to enable them exchange information on a wireless platform with a smartphone.

In the second embodiment, the said card can be used in baseball including major league baseball. It can also be utilized in basketball such as the national basketball association and the professional basketball league in North America. In a third embodiment, the said sports trading card can be linked to a designed sports websites such as nfl.com, mlb.com and nba.com

In a third embodiment, the present invention describes a sport trading card, wherein the tagged near-field communication to the card is programmed to register and transmit relevant information of a player to the card. The information of an active player to the card comprises the player's statistics, highlights and latest news on the said player. The displayed players highlights of a player comprise name, injuries, transactions, health & safety, height, weight, arms, hands, experience, college, age and hometown. The displayed players statistics comprise scores, injuries, lost penalties and leagues the displayed highlights of an active player will be on weekly basis.

In a similar embodiment, the registered information of a retired player to the card comprises the player's their all-time highlights from their careers.

In fourth embodiment, said invention teaches of a novel method of integrating near field communication tag in the middle of the back of a sport trading card used for contactless communication and transmission of information in a smartphone via a browser after the registration as taught in FIG. 6.

The said method comprises steps of tagging NFC to the middle back of NFL sports card at step (601), programming the tag of a player to their NFL.com site at step (602), laying the card face down and tag up, spraying the back of the card with white spray paint, letting the paint to dry at step (603), adding an NFL logo sticker to the back to cover up the NFC tag, scanning user's phone to pull up the website to see information highlights of the player at step (604), pulling up the specific players stats, news and highlights, upon registering via a phone, the App would immediately direct the user to the desired player's information through your phone's browser at step (605), ensuring that the said information contain the player's statistics, news, pictures, and highlights for the player, ensuring that information on the active players comprises their best highlights and weekly highlights, and making sure that for retired players the highlights comprise their all-time highlights from their careers.

### INDUSTRIAL APPLICATION

The present invention is applicable in the sports industry covering NFL, MLB and NBA. It introduces a sports trading card is integrated with near field communication for contactless communication and transmission of information to smart phone via a browser after the registration. It will be used by many sports fans covering a vast and more fans and sport lovers around the globe since they will retrieve firsthand information for authenticated sports websites. Inevitably, moments such sports card have been increasing in value over the last few years due to demand and supply chain, inflation and economic adjustments. The said sports card will promote sport betting industry due to better understanding of the game knowing their superstars of the game. It's a win-win situation to every player of industry here. NFC technology on the cards people will be more interesting by trading with this card.

1. A sport trading card, comprising:
a card with a picture of a subject on the card, wherein the subject is a sports player;
an integrated near field communication to transmit first information to a smartphone and display second information based on the first information via a browser on the smartphone after a registration, wherein the near field communication is pre-programmed to transmit the first information based on the subject on the card, and wherein the registration includes approving display the second information on the smartphone.

2. The sport trading card according to claim 1, wherein the near field communication is integrated at the back of the card.

3. The sport trading card according to claim 2, wherein the near field communication is tagged on the back of the card and aligned at the centre of the card with the air already programmed chips such that the said chips are within few centimeters of each other to enable them exchange information on a wireless platform with a smartphone.

4. The sport trading card according to claim 3, wherein the sport is baseball.

5. The sport card according to claim 4, wherein the baseball sport is the major league baseball.

6. The sport trading card according to claim 3, wherein the sport is basketball.

7. The sport trading card according to claim 6, wherein the basketball is a national basketball association.

6. The sport trading card according to claim 7, wherein the national basketball association is the professional basketball league in North America.

9. The sport trading card according to claim 1, wherein the first information includes designed sport's website of the player.

10. The sport trading card according to claim 9, wherein the designed site is nfl.com.

11. The sport trading card according to claim 9, wherein the designed site is mlb.com.

12. The sport trading card according to claim 9, wherein the designed site is nba.com.

13. The sport trading card according to claim 3, wherein the tagged near-field communication to the card is programmed to display the second information based on the first information via the browser on the smartphone, wherein the second information includes relevant information of the player on the card.

14. The sport trading card according to claim 13, wherein the second information of an active player on the card comprises the player's statistics, highlights and later news on the said player.

15. The sport trading according to claim 14, wherein the displayed player's highlights of a player comprise name, injuries, transactions, health & safety, height, weight, arms, hands, experience, college, age and hometown.

16. The sport trading card according to claim 14, wherein the displayed player's statistics comprise scores, injuries, lost penalties and leagues.

17. The sport trading card according to claim 14, wherein the displayed highlights of an active player will be on weekly basis.

18. The sport trading card according to claim 13, wherein the second information of a retired player on the card comprises the player's all-time highlights from the player's career.

19. A method of integrating near field communication tag in a sports trading card for contactless communication and transmission of information to a smartphone via a browser, comprising:
a. tagging NFC between a front cover and a back cover an NFL sports card;
b. programming the tagged NFC based on a player picture on the front cover of the NFL sports card;
g. scanning the NFL sports card via user's phone to pull up the website to see information highlights of the player;
h. displaying the information of the player on the user's phone via browser based on an approval via the user's phone, wherein the information includes statistics, news, pictures, and highlights of the player, wherein the highlights include best highlights and weekly highlights based on the player is an active player, and wherein the highlights include all time highlights of the player's career based on the player is a retired player.
